(19) United States
(12) Patent Application Publication
(10) Pub. No.: US 2014/0305917 A1
(43) Pub. Date: Oct. 16, 2014

(54) LASER PROCESSING APPARATUS AND LASER PROCESSING METHOD

(71) Applicant: Disco Corporation, Tokyo (JP)

(72) Inventor: Michael Gadd, Tokyo (JP)

(73) Assignee: Disco Corporation, Tokyo (JP)

(21) Appl. No.: 14/248,838

(22) Filed: Apr. 9, 2014

(30) Foreign Application Priority Data
Apr. 11, 2013 (JP) 2013-083161

(51) Int. Cl. B23K 26/14; B23K 26/36

(52) U.S. Cl. CPC B23K 26/1405; B23K 26/36
USPC 219/121.72; 219/121.67

(57) ABSTRACT

A laser processing apparatus includes a chuck table for holding a workpiece. A laser beam is applied to the workpiece. A laser beam oscillating unit oscillates the laser beam and a processing head having a focusing lens focuses the laser beam. A dust collecting unit collects debris generated by the application of the laser beam. The dust collecting unit includes a suction passage having an opening for allowing passage of the laser beam to be focused onto the workpiece by the focusing lens. The suction passage extends symmetrically with respect to the opening, and a vacuum source draws the debris. The suction passage has a first end and a second end selectively connected to the vacuum source.

### BACKGROUND OF THE INVENTION

1. Field of the Invention

The present invention relates to a laser processing apparatus and a laser processing method of applying a laser beam to a workpiece such as a wafer to perform laser processing.

2. Description of the Related Art

In a semiconductor device fabrication process, a plurality of crossing division lines called streets are formed on the front side of a substantially disk-shaped semiconductor wafer to thereby partition a plurality of regions where a plurality of devices such as ICs and LSIs are respectively formed. The semiconductor wafer is cut along the streets to thereby obtain a plurality of individual semiconductor chips. Further, an optical device wafer is provided by forming a plurality of optical devices such as light emitting diodes (LEDs) and laser diodes (LDs) on the front side of a sapphire substrate. The optical device wafer is also cut along the streets to obtain the individual optical devices divided from each other, which are widely used in electronic equipment.

As a method of dividing a wafer such as a semiconductor wafer and an optical device wafer along the streets, there has been proposed a method of applying a pulsed laser beam having an absorption wavelength to the wafer along the streets to thereby form laser processed grooves along the streets on the wafer by ablation, and next breaking the wafer along these laser processed grooves. However, when the laser beam is applied to the wafer formed of silicon or sapphire in the laser processing step mentioned above, the wafer is melted to cause the generation of melt dust, or fine dust particles called debris, so that there arises a problem such that the dust may scatter and stick to the front side of the devices formed on the wafer, causing a degradation in quality of each device. Further, there is another problem such that the dust scattered may stick to a focusing objective lens included in focusing means for applying a laser beam, causing the interference with the application of the laser beam.

The generation of such debris is not limited in the case of ablation, but a certain amount of debris is generated from the front side of a wafer also in the case of applying a laser beam having a transmission wavelength to the wafer so as to focus the laser beam inside the wafer, thereby forming a modified layer inside the wafer. To cope with this problem, there has been proposed a laser processing apparatus including dust removing means having an air nozzle for blowing air along the optical axis of a focusing objective lens, wherein debris is sucked from the periphery of the air nozzle to thereby prevent the debris from sticking to the front side of each device (see Japanese Patent Laid-open Nos. 2007-69249 and 2011-121099, for example).

### SUMMARY OF THE INVENTION

The laser processing apparatus disclosed in Japanese Patent Laid-open Nos. 2007-69249 and 2011-121099 has effected the removal of debris to some extent. However, it is difficult to sufficiently remove debris and a further improvement is desired.

It is therefore an object of the present invention to provide a laser processing apparatus and a laser processing method which can efficiently collect and remove the debris generated in performing laser processing to a workpiece.

In accordance with an aspect of the present invention, there is provided a laser processing apparatus including: holding means for holding a workpiece; laser beam applying means for applying a laser beam to the workpiece held by the holding means, the laser beam applying means including laser beam oscillating means for oscillating the laser beam and a processing head having a focusing lens for focusing the laser beam oscillated by the laser beam oscillating means; and dust collecting means for collecting debris generated by the application of the laser beam focused by the focusing lens to the workpiece, the dust collecting means including a suction passage having an opening for allowing the pass of the laser beam to be focused onto the workpiece by the focusing lens, the suction passage extending symmetrically with respect to the opening, and a vacuum source for sucking the debris, the suction passage having a first end and a second end selectively connected to the vacuum source.

In accordance with another aspect of the present invention, there is provided a laser processing method of performing laser processing to a workpiece having a plurality of process lines thereon by using a laser processing apparatus. The laser processing apparatus includes: holding means for holding the workpiece; laser beam applying means for applying a laser beam to the workpiece held by the holding means, the laser beam applying means including laser beam oscillating means for oscillating the laser beam and a processing head having a focusing lens for focusing the laser beam oscillated by the laser beam oscillating means; and dust collecting means for collecting debris generated by the application of the laser beam focused by the focusing lens to the workpiece, the dust collecting means including a suction passage having an opening for allowing the pass of the laser beam to be focused onto the workpiece by the focusing lens, the suction passage extending symmetrically with respect to the opening, and a vacuum source for sucking the debris, the suction passage having a first end and a second end selectively connected to the vacuum source. The laser processing method includes: a holding step of holding the workpiece by using the holding means; a positioning step of positioning the workpiece held by the holding means so that the process lines of the workpiece become parallel to the direction of extension of the suction passage constituting the dust collecting means; a laser processing step of performing laser processing along a first one of the process lines from one end to the other end thereof by using the laser beam applying means after performing the positioning step, and next performing laser processing along a second one of the process lines adjacent to the first process line from the other end to one end thereof by using the laser beam applying means; and a sucking step of operating the vacuum source during the performance of the laser processing step to suck the debris generated in the laser processing step through the opening into the suction passage, thereby removing the debris from the workpiece, wherein one of the first end and the second end of the suction passage on the downstream side of a laser processing point in a process proceeding direction where the laser processing to the workpiece proceeds is connected to the vacuum source, and the other of the first and second ends is closed.

According to the laser processing apparatus of the present invention, the dust collecting means is provided adjacent to the processing head, and the first end and the second end of the suction passage of the dust collecting means are selectively connected to the vacuum source. Accordingly, by selectively connecting the first end and the second end of the suction passage to the vacuum source in performing the laser processing in a first direction and the laser processing in a second direction opposite to the first direction, the debris generated in performing the laser processing in each direction can be efficiently collected and removed from the workpiece.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus according to a preferred embodiment of the present invention;

FIG. 2 is a block diagram of a laser beam applying unit;

FIG. 3 is a perspective view of a semiconductor wafer as viewed from the front side thereof;

FIG. 4 is a perspective view of a wafer unit;

FIG. 5 is a partially sectional side view of a processing head and dust collecting means;

FIG. 6 is a schematic plan view showing opposite process proceeding directions in a laser processing method;

FIG. 7 is a partially sectional side view for illustrating the operation of the dust collecting means in the case that the laser processing proceeds in the direction shown by an arrow X2; and

FIG. 8 is a partially sectional side view for illustrating the operation of the dust collecting means in the case that the laser processing proceeds in the direction shown by an arrow X1.

### DETAILED DESCRIPTION OF THE PREFERRED EMBODIMENT

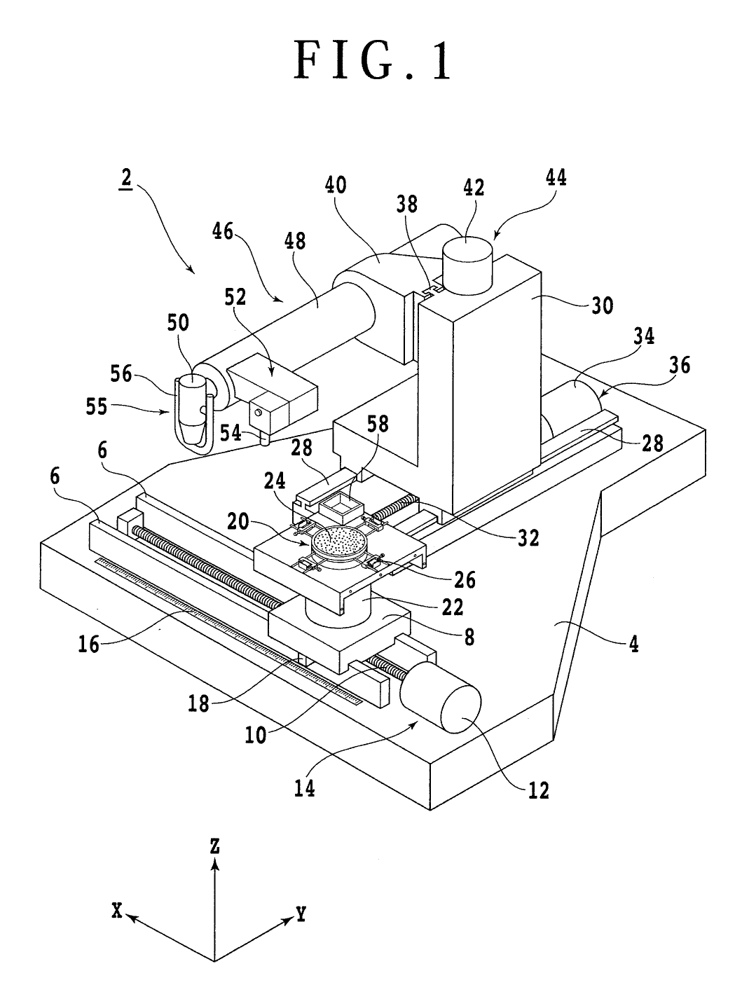

A preferred embodiment of the present invention will now be described in detail with reference to the drawings. Referring to FIG. 1, there is shown a perspective view of a laser processing apparatus 2 according to a preferred embodiment of the present invention. The laser processing apparatus 2 includes a stationary base 4 and a pair of guide rails 6 fixedly mounted on the stationary base 4 so as to extend in a feeding direction (X direction) shown by an arrow X in FIG. 1. An X-axis slide block 8 is slidably mounted on the guide rails 6 so as to be movable in the X direction by an X-axis moving mechanism (feeding mechanism) 14. The X-axis moving mechanism 14 is composed of a ball screw 10 and a pulse motor 12 for rotating the ball screw 10. A chuck table 20 as holding means is mounted through a cylindrical supporting member 22 on the X-axis slide block 8.

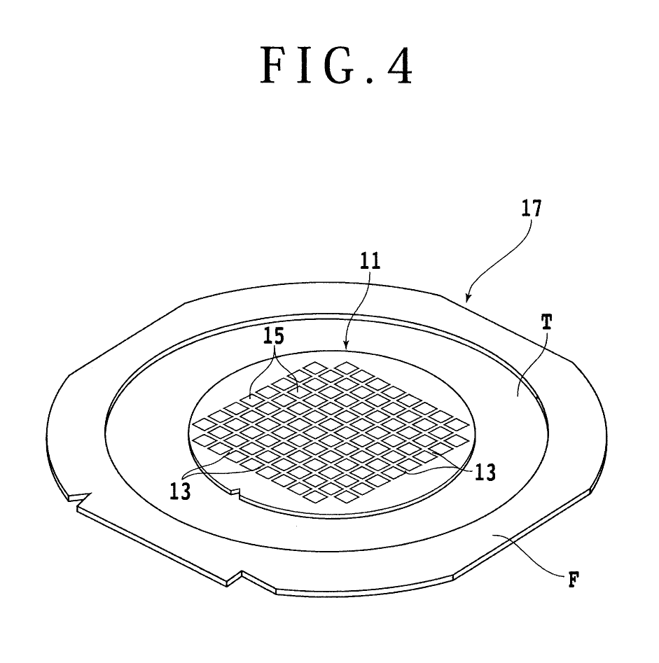

The chuck table 20 has a suction holding portion (vacuum chuck) 24 formed of porous ceramic. The chuck table 20 is provided with a plurality of (four in this preferred embodiment) clamps 26 for clamping an annular frame F shown in FIG. 4. The X-axis moving mechanism 14 includes a scale 16 provided on the stationary base 4 so as to extend along the guide rails 6 and a read head 18 provided on the lower surface of the X-axis slide block 8 for reading an X coordinate value marked on the scale 16. The read head 18 is connected to a controller (not shown) included in the laser processing apparatus 2.

A pair of guide rails 28 are fixedly mounted on the stationary base 4 so as to extend in an indexing direction (Y direction) shown by an arrow Y in FIG. 1. A Y-axis slide block 30 is slidably mounted on the guide rails 28 so as to be movable in the Y direction by a Y-axis moving mechanism (indexing mechanism) 36. The Y-axis moving mechanism 36 is composed of a ball screw 32 and a pulse motor 34 for rotating the ball screw 32. A pair of guide rails 38 (one of which being shown) are formed on the Y-axis slide block 30 so as to extend in a Z direction shown by an arrow Z in FIG. 1. A Z-axis slide block 40 is slidably mounted on the guide rails 38 so as to be movable in the Z direction by a Z-axis moving mechanism 44. The Z-axis moving mechanism 44 is composed of a ball screw (not shown) and a pulse motor 42 for rotating this ball screw. In the laser processing apparatus 2 shown in FIG. 1, a processing head 50 to be hereinafter described in detail is movable in the Y direction by the Y-axis moving mechanism 36. As a modification, the processing head 50 may be fixed in the Y direction and the chuck table 20 may be movable both in the X direction and in the Y direction.

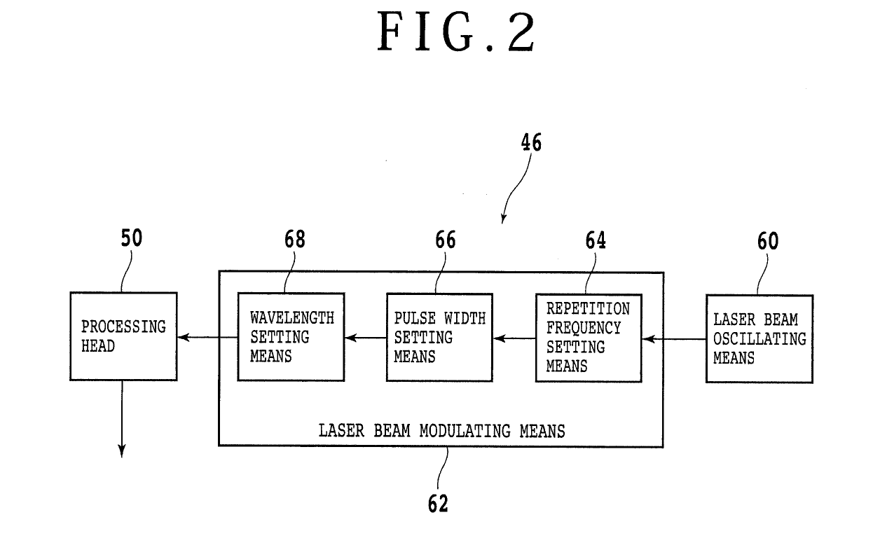

A laser beam applying unit (laser beam applying means) 46 is fixedly supported to the Z-axis slide block 40. The laser beam applying unit 46 includes a casing 48 extending in the Y direction from the Z-axis slide block 40. The casing 48 contains laser beam oscillating means etc. to be hereinafter described. The processing head 50 for focusing a laser beam onto a workpiece to be laser-processed is mounted on the front end of the casing 48. As shown in FIG. 2, the laser beam applying unit 46 includes the processing head 50, laser beam oscillating means 60, and laser beam modulating means 62. The laser beam oscillating means 60 and the laser beam modulating means 62 are provided in the casing 48.

Examples of the laser beam oscillating means 60 include a YAG laser oscillator and a YVO4 laser oscillator. The laser beam modulating means 62 includes repetition frequency setting means 64, pulse width setting means 66, and wavelength setting means 68. The repetition frequency setting means 64, the pulse width setting means 66, and the wavelength setting means 68 are known in the art and the detailed description thereof will be omitted herein.

An alignment unit (alignment means) 52 is mounted on the casing 48. The alignment unit 52 includes an imaging unit (imaging means) 54 for imaging a workpiece held on the chuck table 20. The imaging unit 54 is aligned with the processing head 50 in the X direction. The processing head 50 is provided with dust collecting means 55 for collecting debris generated by the application of a laser beam from the processing head 50 to the workpiece. The dust collecting means 55 includes a U-shaped suction pipe 56 mounted to the processing head 50. The suction pipe 56 forms a suction passage therein as hereinafter described. The suction pipe 56 is mounted to the processing head 50 in such a manner that the plane containing the center of the suction passage is parallel to the X direction. A box 58 for storing a cleaning water is provided adjacent to the chuck table 20. The lower end portion of the suction pipe 56 is adapted to be immersed in the cleaning water stored in the box 58, thereby cleaning the inside of the suction pipe 56 to remove the debris deposited on the inner wall of the suction pipe 56.

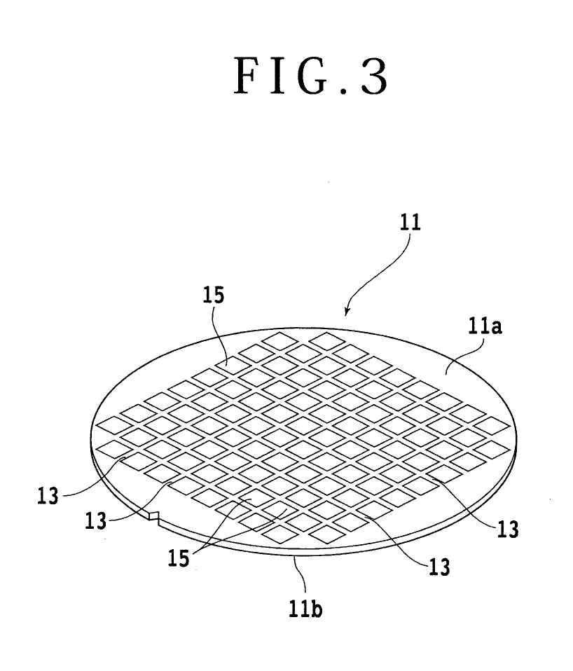

Referring to FIG. 3, there is shown a perspective view of a semiconductor wafer (which will be hereinafter referred to also simply as wafer) 11 as a kind of workpiece to be processed by the laser processing apparatus 2 as viewed from the front side thereof. The wafer 11 has a front side 11a and a back side 11b. A plurality of crossing division lines (streets) 13 are formed on the front side 11a of the wafer 11 to thereby define a plurality of separate regions where a plurality of devices 15 such as ICs and LSIs are respectively formed. Prior to performing laser processing to the wafer 11, the back side 11b of the wafer 11 is attached to a dicing tape T supported at its peripheral portion to the annular frame F, thereby forming a wafer unit 17 as shown in FIG. 4. That is, the wafer unit 17 is loaded to the laser processing apparatus 2 in performing the laser processing.

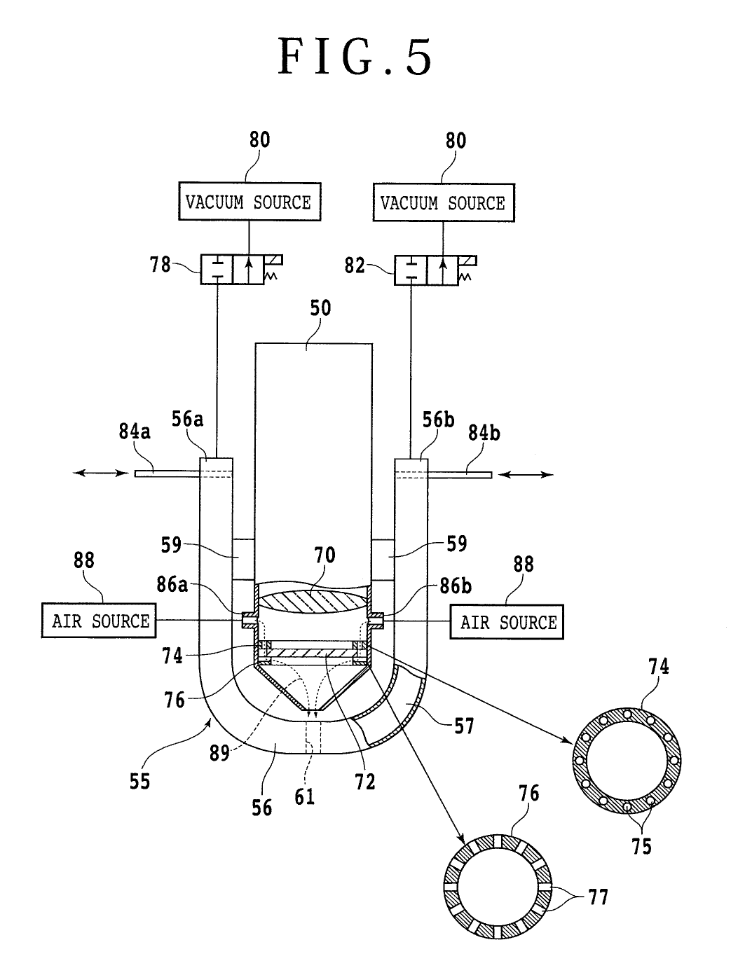

Referring to FIG. 5, there is shown a partially sectional side view of the processing head 50 and the dust collecting means 55 constituting an essential part of the present invention. A focusing lens 70 is mounted in the processing head 50. A glass window 72 as a protective cover for the focusing lens 70 is fixed in the processing head 50 at a lower end portion thereof below the focusing lens 70 in such a manner that the glass window 72 is sandwiched by a pair of upper and lower annular mounting members 74 and 76. The upper annular mounting member 74 has a plurality of round holes 75 arranged at predetermined intervals in the circumferential direction. Similarly, the lower annular mounting member 76 has a plurality of radial grooves 77 arranged at predetermined intervals in the circumferential direction. In the condition where the glass window 72 is sandwiched by the annular mounting members 74 and 76, the plural round holes 75 of the annular mounting member 74 are in communication with the plural radial grooves 77 of the annular mounting member 76.

The dust collecting means 55 for collecting the debris generated in performing the laser processing includes the U-shaped suction pipe 56 forming a suction passage 57 therein. An opening 61 for allowing the pass of a laser beam applied through the focusing lens 70 is formed at the center of the lower end portion of the suction pipe 56. The suction pipe 56 is symmetrical with respect to the opening 61 as viewed in FIG. 5. The size of the opening 61 is set to about 2.5×5 mm, for example. The suction pipe 56 is mounted through a pair of mounting portions 59 to the processing head 50. In the condition where the suction pipe 56 is mounted to the processing head 50, the plane containing the center of the suction passage 57 formed by the suction pipe 56 is parallel to the X direction shown in FIG. 1.

One end (first end) 56a of the suction pipe 56 is connected through an electromagnetic selector valve 78 to a vacuum source 80, and the other end (second end) 56b of the suction pipe 56 is also connected through an electromagnetic selector valve 82 to the vacuum source 80. The first end 56a and the second end 56b of the suction pipe 56 are selectively brought into communication with the vacuum source 80 by the operation of the electromagnetic selector valves 78 and 82. A shutter 84a is provided in the vicinity of the first end 56a of the suction pipe 56, and a shutter 84b is provided in the vicinity of the second end 56b of the suction pipe 56. The shutter 84a is operated in concert with the operation of the electromagnetic selector valve 78. That is, when the electromagnetic selector valve 78 is in an OFF position (closed position), the shutter 84a is operated to close the first end 56a of the suction pipe 56. Conversely, when the electromagnetic selector valve 78 is in an ON position (open position), the shutter 84a is operated to open the first end 56a of the suction pipe 56. That is, the shutter 84a is retracted from the suction passage 57 to make the communication between the suction passage 57 and the vacuum source 80 through the electromagnetic selector valve 78.

Similarly, the shutter 84b is operated in concert with the operation of the electromagnetic selector valve 82. That is, when the electromagnetic selector valve 82 is in an OFF position (closed position), the shutter 84b is operated to close the second end 56b of the suction pipe 56. Conversely, when the electromagnetic selector valve 82 is in an ON position (open position), the shutter 84b is operated to open the second end 56b of the suction pipe 56. That is, the shutter 84b is retracted from the suction passage 57 to make the communication between the suction passage 57 and the vacuum source 80 through the electromagnetic selector valve 82. The vacuum source 80 is capable of sucking air at a rate of about 280 liters/min, for example. On the other hand, a pair of air inlets 86a and 86b are formed through the side wall of the processing head 50 at a vertical position between the focusing lens 70 and the glass window 72. These air inlets 86a and 86b are connected to an air source 88 for supplying compressed air.

There will now be described a laser processing method of performing the laser processing to the wafer 11 along the division lines 13 by using the laser processing apparatus 2. First, a holding step is performed in such a manner that the wafer unit 17 shown in FIG. 4 is held on the chuck table 20 and the annular frame F is fixed by the clamps 26. Thereafter, the chuck table 20 is moved to a position where the wafer 11 is directly below the imaging unit 54, and the front side 11a of the wafer 11 is imaged by the imaging unit 54 to make the division lines 13 extending in a first direction parallel to the X direction. Further, the processing head 50 is suitably moved in the Y direction to make the alignment with a predetermined one of the division lines 13 extending in the first direction (alignment operation). Accordingly, this predetermined division line (first division line) 13 of the wafer 11 held on the chuck table 20 is positioned parallel to the plane containing the center of the suction passage 57 of the dust collecting means 55 (positioning step).

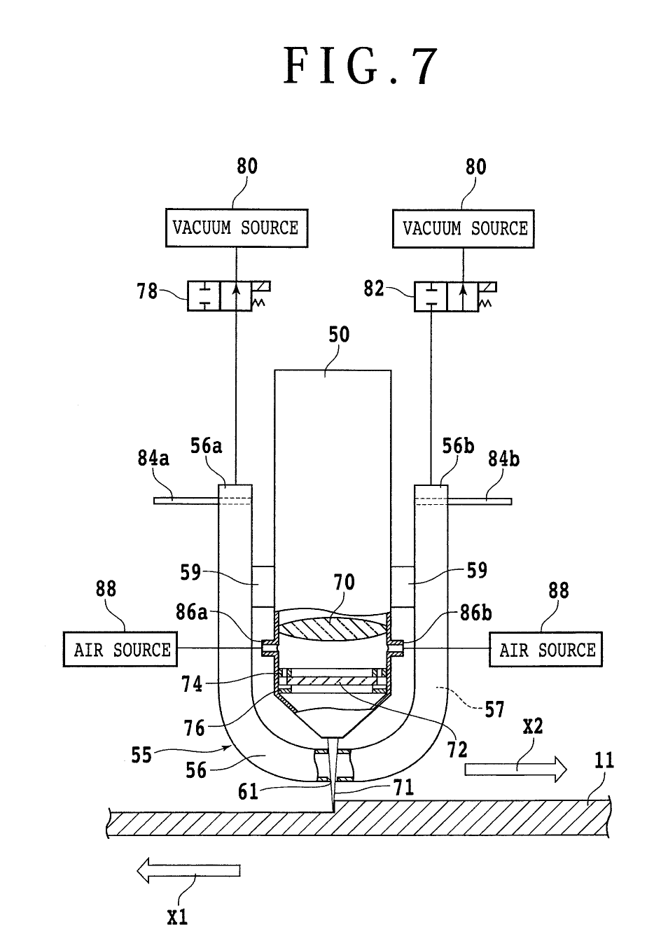

After performing the positioning step, the wafer 11 held on the chuck table 20 is fed in the direction shown by an arrow X1 in FIG. 7. At the same time, a laser beam 71 having a wavelength of 355 nm, for example, is applied through the focusing lens 70 of the processing head 50 to the wafer 11 along the first division line 13, thus performing the laser processing from one end to the other end of the first division line 13 (forward processing). In the forward processing, the wafer 11 is fed in the direction of the arrow X1 in FIG. 7, so that the laser processing proceeds in the direction shown by an arrow X2 in FIG. 7.

In performing the forward processing mentioned above, the electromagnetic selector valve 78 is operated to take the ON position and the shutter 84a is operated to open the first end 56a of the suction pipe 56, thereby making the communication between the suction passage 57 and the vacuum source 80 through the electromagnetic selector valve 78. At the same time, the electromagnetic selector valve 82 is operated to take the OFF position and the shutter 84b is operated to close the second end 56b of the suction pipe 56. Accordingly, the suction passage 57 is brought into communication with the vacuum source 80 through the first end 56a of the suction pipe 56. Further, in performing the forward processing, compressed air is supplied from the air source 88 through the air inlets 86a and 86b into the processing head 50 as shown by a broken line arrow 89 in FIG. 5, in order to prevent the debris from sticking to the glass window 72. The air source 88 is capable of supplying compressed air at a rate of about 30 liters/min, for example. The air supplied from the air source 88 through the air inlets 86a and 86b into the processing head 50 is allowed to pass through the round holes 75 of the annular mounting member 74 and the radial grooves 77 of the annular mounting member 76 and flow inside the processing head 50 as shown by the arrow 89, finally being discharged from the lower end opening of the processing head 50.

In performing ablation to the wafer 11 by using the laser beam 71 to thereby form a laser processed groove along the first division line 13 as mentioned above, debris (dust) is generated at a laser processing point on the wafer 11. This debris is sucked into the suction passage 57 through the opening 61 of the suction pipe 56 constituting the dust collecting means 55 and removed through the first end 56a of the suction pipe 56 and the electromagnetic selector valve 78 to the vacuum source 80 (sucking step).

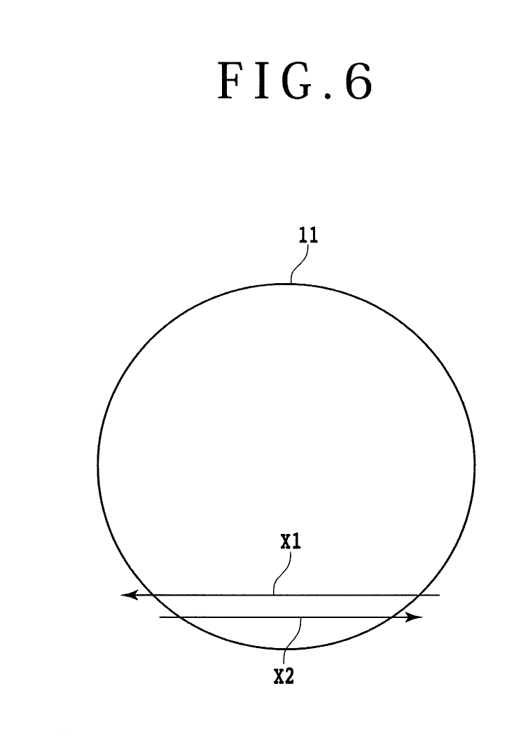

Although not especially shown in FIG. 7, the air 89 (see FIG. 5) flows inside the lower end portion of the processing head 50, thereby preventing the debris from sticking to the glass window 72. After performing the laser processing in the forward direction shown by an arrow X2 in FIG. 6 from one end to the other end of the first division line 13, the next division line (second division line) 13 adjacent to the first division line 13 is indexed and the laser processing is similarly performed in the backward direction shown by an arrow X1 in FIG. 6 from the other end to one end of the second division line 13 (backward processing).

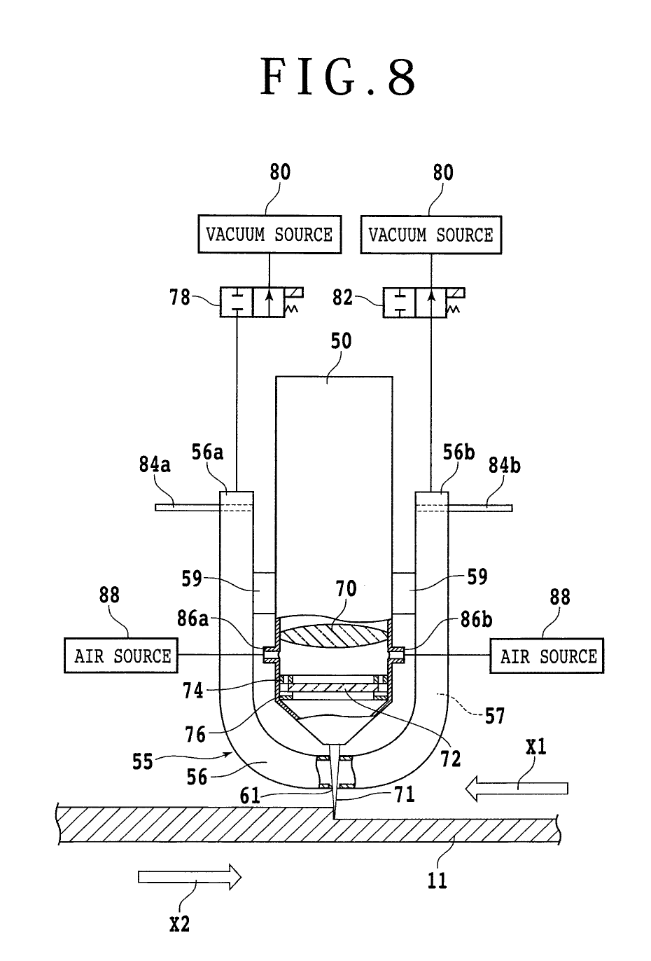

The backward processing will now be described with reference to FIG. 8. In performing the backward processing, the wafer 11 held on the chuck table 20 is fed in the direction shown by an arrow X2 in FIG. 8, so that the laser processing proceeds in the direction shown by an arrow X1 in FIG. 8. In performing the backward processing mentioned above, the electromagnetic selector valve 82 is operated to take the ON position and the shutter 84b is operated to open the second end 56b of the suction pipe 56, thereby making the communication between the suction passage 57 and the vacuum source 80 through the second end 56b of the suction pipe 56 and the electromagnetic selector valve 82. At the same time, the electromagnetic selector valve 78 is operated to take the OFF position and the shutter 84a is operated to close the first end 56a of the suction pipe 56.

The debris generated at a laser processing point on the wafer 11 in performing the backward processing is sucked into the suction passage 57 through the opening 61 of the suction pipe 56 and removed through the second end 56b of the suction pipe 56 and the electromagnetic selector valve 82 to the vacuum source 80 (sucking step). Although not especially shown in FIG. 8, compressed air is supplied from the air source 88 through the air inlets 86a and 86b into the processing head 50 and then allowed to flow inside the processing head 50 as shown by the arrow 89 in FIG. 5, thereby preventing the debris from sticking to the glass window 72.

As described above, the laser processing method using the laser processing apparatus 2 according to this preferred embodiment is characterized in the following point. In performing the forward processing as shown in FIG. 7, the first end 56a of the suction pipe 56 on the downstream side of the laser processing point in the process proceeding direction shown by the arrow X2 in FIG. 7 is brought into communication with the vacuum source 80, and the second end 56b of the suction pipe 56 is closed by the shutter 84b. The wafer 11 is moved in the feeding direction shown by the arrow X1 in FIG. 7, so that the amount of debris generated is larger on the downstream side of the laser processing point in the process proceeding direction than on the upstream side thereof. Accordingly, by sucking the debris from the first end 56a of the suction pipe 56 on the downstream side of the laser processing point in the process proceeding direction shown by the arrow X2 in FIG. 7, the debris can be efficiently removed.

On the other hand, in performing the backward processing as shown in FIG. 8, the second end 56b of the suction pipe 56 on the downstream side of the laser processing point in the process proceeding direction shown by the arrow X1 in FIG. 8 is brought into communication with the vacuum source 80, and the first end 56a of the suction pipe 56 is closed by the shutter 84a. The wafer 11 is moved in the feeding direction shown by the arrow X2 in FIG. 8, so that the amount of debris generated is larger on the downstream side of the laser processing point in the process proceeding direction than on the upstream side thereof. Accordingly, by sucking the debris from the second end 56b of the suction pipe 56 on the downstream side of the laser processing point in the process proceeding direction shown by the arrow X1 in FIG. 8, the debris can be efficiently removed.

In summary, one of the first end 56a and the second end 56b of the suction pipe 56 forming the suction passage 57 on the downstream side of the laser processing point in the process proceeding direction where the laser processing to the wafer 11 proceeds is brought into communication with the vacuum source 80, and the other of the first and second ends 56a and 56b is closed by the shutter 84a or 84b. With this configuration, the debris generated in performing the laser processing can be efficiently collected and removed from the wafer 11. When the laser processing is repeated, the debris may be deposited on the inner wall of the suction pipe 56. Accordingly, the lower end portion of the suction pipe 56 is preferably immersed in the cleaning water stored in the box 58 with predetermined timing (e.g., after processing a predetermined number of wafers 11) or at any suitable convenient time. Thereafter, both the first end 56a and the second end 56b of the suction pipe 56 are brought into communication with the vacuum source 80 to thereby suck the cleaning water, so that the debris deposited on the inner wall of the suction pipe 56 is removed by the cleaning water. As a modification, the cleaning water may be supplied into the suction pipe 56 in performing the laser processing, thereby preventing the debris sucked from being deposited onto the inner wall of the suction pipe 56.

While the laser processing method according to this preferred embodiment is applied to the case of performing ablation to the wafer 11, the present invention is not limited to this preferred embodiment. Also in the case of SD (stealth dicing) such that the focal point of a laser beam having a transmission wavelength (e.g., 1064 nm) to the wafer 11 is set inside the wafer 11 to form a modified layer inside the wafer 11, a certain amount of debris is generated from the front side of the wafer 11 to which the laser beam is applied. Accordingly, the dust collecting means 55 in this preferred embodiment is also effective in this case.

Further, while the laser processing method of the present invention is applied to the semiconductor wafer 11 having a pattern (the division lines 13 and the devices 15) on the front side as a workpiece in this preferred embodiment, the present invention is not limited to this preferred embodiment, but it is also applicable to a platelike workpiece having no pattern on the front side. Further, while the dust collecting means 55 is provided on the processing head 50 in this preferred embodiment, the arrangement of the dust collecting means in the present invention is not limited to that in this preferred embodiment. For example, the suction pipe constituting the dust collecting means in the present invention may be mounted on the Y-axis slide block 30 shown in FIG. 1 and the front end portion of the suction pipe may be located near the lower end portion of the processing head 50 so as to effect the suction of debris.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
holding means for holding a workpiece;
laser beam applying means for applying a laser beam to the workpiece held by the holding means, the laser beam applying means including laser beam oscillating means for oscillating the laser beam and a processing head having a focusing lens for focusing the laser beam oscillated by the laser beam oscillating means; and
dust collecting means for collecting debris generated by the application of the laser beam focused by the focusing lens to the workpiece, the dust collecting means including a suction passage having an opening for allowing the pass of the laser beam to be focused onto the workpiece by the focusing lens, the suction passage extending symmetrically with respect to the opening, and a vacuum source for sucking the debris, the suction passage having a first end and a second end selectively connected to the vacuum source.

2. A laser processing method of performing laser processing to a workpiece having a plurality of process lines thereon by using a laser processing apparatus including holding means for holding the workpiece, laser beam applying means for applying a laser beam to the workpiece held by the holding means, the laser beam applying means including laser beam oscillating means for oscillating the laser beam and a processing head having a focusing lens for focusing the laser beam oscillated by the laser beam oscillating means, and dust collecting means for collecting debris generated by the application of the laser beam focused by the focusing lens to the workpiece, the dust collecting means including a suction passage having an opening for allowing the pass of the laser beam to be focused onto the workpiece by the focusing lens, the suction passage extending symmetrically with respect to the opening, and a vacuum source for sucking the debris, the suction passage having a first end and a second end selectively connected to the vacuum source, the laser processing method comprising:
a holding step of holding the workpiece by using the holding means;
a positioning step of positioning the workpiece held by the holding means so that the process lines of the workpiece become parallel to the direction of extension of the suction passage constituting the dust collecting means;
a laser processing step of performing laser processing along a first one of the process lines from one end to the other end thereof by using the laser beam applying means after performing the positioning step, and next performing laser processing along a second one of the process lines adjacent to the first process line from the other end to one end thereof by using the laser beam applying means; and
a sucking step of operating the vacuum source during the performance of the laser processing step to suck the debris generated in the laser processing step through the opening into the suction passage, thereby removing the debris from the workpiece,
wherein one of the first end and the second end of the suction passage on the downstream side of a laser processing point in a process proceeding direction where the laser processing to the workpiece proceeds is connected to the vacuum source, and the other of the first and second ends is closed.
